(19) United States
(12) Patent Application Publication
(10) Pub. No.: US 2011/0295845 A1
(43) Pub. Date: Dec. 1, 2011

(54) Semi-Supervised Page Importance Ranking

(75) Inventors: Bin Gao, Beijing (CN); Taifeng Wang, Beijing (CN); Tie-Yan Liu, Beijing (CN)

(73) Assignee: MICROSOFT CORPORATION, Redmond, WA (US)

(21) Appl. No.: 12/789,278

(22) Filed: May 27, 2010

(51) Int. Cl. G06F 17/30

(52) U.S. Cl. 707/723; 707/E17.108

(57) ABSTRACT

Importance ranking of web pages is performed by defining a graph-based regularization term based on document features, edge features, and a web graph of a plurality of web pages, and deriving a loss term based on human feedback data. The graph-based regularization term and the loss term are combined to obtain a global objective function. The global objective function is optimized to obtain parameters for the document features and edge features and to produce static rank scores for the plurality of web pages. Further, the plurality of web pages is ordered based on the static rank scores.

### BACKGROUND

Static ranking, also known as page importance ranking, is the query-independent ordering of web pages that distinguishes popular web pages from unpopular ones. Accordingly, page importance ranking may play a significant role in the operation of web search engine. For example, page importance ranking may be used in web page crawling, index selection, website spoof detection, and relevance ranking. However, conventional page importance ranking algorithms may rank web pages in ways that are inconsistent with human intuition, which may lead to web search results that do not appear to be reasonable to an average web user.

### SUMMARY

Described herein is a semi-supervised page ranking technique that incorporates human feedback data to enable search engines to produce rankings of web pages that are consistent with human intuition. Thus, search engines that employ the semi-supervised page ranking technique described herein produce intuitive rankings of web pages. As a result, the search engine also returns web search results that appear more reasonable to an average web user than results from conventional search engines.

The semi-supervised ranking technique may initially involve defining a graph-based regularization term for static rank algorithms, in which edge features and document features of a multiple web pages are combined with a small number of parameters. Human feedback data may then be introduced as supervised information to define a loss term. The combination of the graph-based regularization term and the loss term may generate a global objective function. The global objective function may be optimized to update the parameters, as well as computing the static rank scores for the multiple web pages. In this way, the semi-supervised ranking technique may produce human intuition consistent web search results while minimize the computation cost associated with implementing human feedback into page important ranking.

In at least one embodiment, the human intuition consistent importance ranking is performed by defining a graph-based regularization term based on document features, edge features, and a web graph of a plurality of web pages, and deriving a loss term based on human feedback data. The graph-based regularization term and the loss term are combined to obtain a global objective function. The global objective function is optimized to obtain parameters for the document features and edge features and produce static rank scores for the plurality of web pages. Further, the plurality of web pages is ordered based on the static rank scores.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram of an illustrative scheme that implements a semi-supervised page rank (SSPR) engine that uses human feedback data to produce human intuition consistent importance rankings of web pages.

FIG. 2 is a block diagram of selected components of an illustrative SSPR engine that uses human feedback data to produce human intuition consistent importance rankings of web pages.

FIG. 3 is a flow diagram of an illustrative process to generate human intuition consistent importance ranking of web pages, in accordance with various embodiments.

FIG. 4 is a block diagram of an illustrative electronic device that implements a semi-supervised page rank (SSPR) engine that uses human feedback data to produce human intuition consistent importance rankings of web pages.

### DETAILED DESCRIPTION

A semi-supervised page ranking technique incorporates human feedback data when ranking web pages. In turn, when a search engine performs a search against the ranked web pages, the search engine returns web page search results that are consistent with human intuition. The semi-supervised page ranking technique employs a semi-supervised learning framework for page importance ranking. In the framework, a parametric ranking model is generated to combine document features extracted from multiple web pages and edge features that describe the relationships between the multiple web pages. For example, a document feature of a particular web page may be the number of inbound links from other web pages to the particular web page. An edge feature for two web pages may be representative of whether the two web pages are intra-website web pages or inter-website web pages. Further, the framework may also involve generating a group of constraints according to human supervision, in other words, based on human feedback data. In this way, the human feedback data may serve to improve the ranking results generated by the parametric ranking model. The semi-supervised page ranking technique uses a graph-based regularization term as an objective function that considers the interconnection of the multiple web pages. By minimizing the objective function that is subject to the group of constraints, the technique may learn the parameters of the parametric model and calculates a page importance ranking for the multiple web pages.

The semi-supervised page ranking technique may be implemented by an example semi-supervised page rank (SSPR) engine. The example SSPR engine may use a graph-based regularization term that is based on a Markov random walk on a web graph of the multiple web pages. The example SSPR engine may also incorporate edge features, as described above, into the transition probability of the Markov process, and incorporate node features into a reset probability. The example SSPR engine may convert constraints from the human feedback data to loss functions (loss term) using the L₂ distance, that is, the Euclidean distance, between the ranking results given by the parametric model and the human feedback data. The objective function, or the graph-based regularization term, of the example SSPR engine may be optimized for parallel implementation on multiple computing devices using Map-Reduce logics.

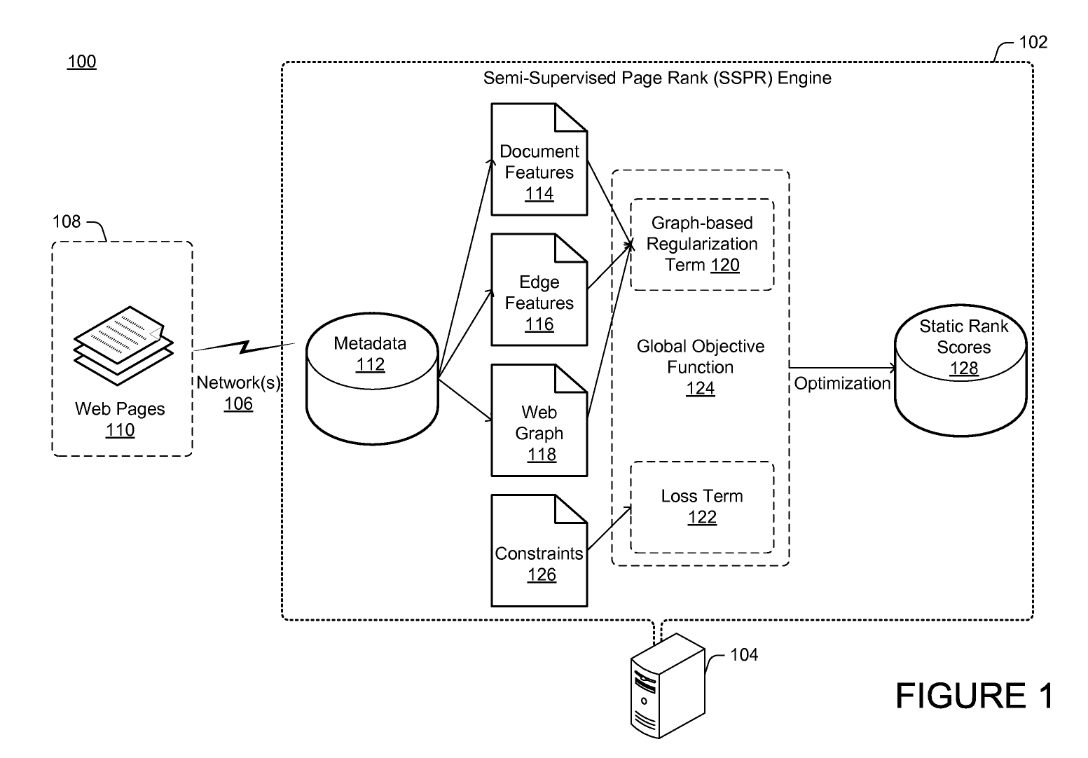

By using a graph-based regularization term and/or the Map-Reduce logics, the web graph that is generated for the page importance ranking calculations may remain relative sparse. As such, the amount of computation for the purpose of page importance ranking may be reduced while the human perceived reasonableness of the output web page rankings may be increased. Accordingly, user satisfaction with web search results of search engines that implement the SSPR engine may be heightened. Various example implementations of the semi-supervised page ranking technique are described below with reference to FIGS. 1-4.

### Illustrative Environment

FIG. 1 is a block diagram of an illustrative scheme that implements a semi-supervised page rank (SSPR) engine that uses human feedback data to produce web page importance rankings that are consistent with human intuition.

The SSPR engine 102 may be implemented on a computing device 104. The computing device 104 may be a general purpose computer, such as a desktop computer, a laptop computer, a server, or the like. In additional embodiments, the SSPR engine 102 may be implemented on a plurality of computing devices 104, such as a plurality of servers of one or more data centers (DCs) or one or more content distribution networks (CDNs). Further, the computing device 104 may have network capabilities. For example, the computing device 104 may exchange data with other electronic devices (e.g., laptops computers, servers, etc.) via one or more networks 106.

The one or more networks 106 may include at least one of wide-area networks (WANs), local area networks (LANs), and/or other network architectures, that connect the one or more computing device 104 to the World Wide Web 108, so that the computing devices 104 may access a plurality of web pages 110 from the various content providers of the World Wide Web 108.

The SSPR engine 102 may produce web page importance rankings that are consistent with human intuition. In various embodiments, the SSPR engine 102 may crawl the World Wide Web 108 to access the content of the web pages 110. During such crawls, the SSPR engine 102 may collect representative metadata 112 regarding the content of the web pages 110, as well as the relationship between the web pages 110. In various embodiments, the number of web pages accessed by the SSPR engine 102 for the purpose of collecting representative metadata 112 may be in order of several billion.

The collected representative metadata 112 may include, for example, document features 114, edge features 116, and a web graph 118. The document features 114 for each web page, also known as node features, may include one or more of (1) the number of inbound links to the web page (node); (2) the number of outbound links from the web page (node); (3) the number of neighboring web pages that are at distance 2, that is, at one or more nodes that are twice removed from the web page (node); (4) the universal resource locator (URL) depth of the web page (node); or (5) the URL length of the web page (node). It will be appreciated that URL depth refers to how many levels deep within a website the web page is found. The level is determined by reviewing the number of slash (“/”) characters in the URL. As such, the greater the number of slash characters in the URL path of a web page, the deeper the URL is for that web page. Likewise, URL length refers to the number of characters that are in a URL of a web page.

The edge features 116 may be derived from the relationship between multiple web pages, these features may include one or more of (1) whether the two web pages are intra-website web pages or inter-website web pages; (2) the number of inbound links of the source and destination web pages (nodes) at each edge; (3) the number of outbound links of the source and destination web pages (nodes) at each edge; (4) the URL depths of the source and destination web pages (nodes) at each edge; or (4) the URL lengths of the source and destination web pages (nodes) at each edge.

The web graph 118 is a directed graph representation of web pages and hyperlinks of the World Wide Web. In the web graph 118, nodes may represent static web pages and hyperlinks may represent directed edges. In at least one embodiment, the web graph 118 may be obtained via the use of a web search engine. A typical web graph may contain approximately one billon web pages (nodes), and several billon hyperlinks (edges). However, the number of nodes and edges in a web graph may grow exponentially over time. Accordingly, the number of nodes and edges in the web graph 118 may differ in various embodiments.

The SSPR engine 102 may define a regularization term 120 based on the representative metadata 112. The SSPR engine 102 may further combine the regularization term with loss term 122 to obtain a global objective function 124. The loss term 122 may be derived from constraints 126 from the human feedback data. In various embodiments, the conversion of the constraints 126 to the loss term 122 may be based on the L₂ distance, that is, the Euclidean distance, between the ranking results given by the parametric model and the human feedback data.

The constraints 126 may be, for example, in the form of binary labels, pair wise preferences, partially ordered sets, or fully ordered sets. In some embodiments, binary labels may be generated via manual annotation. For example, spam and junk web pages may be given the label “zero”, while non-spam and non junk web pages may be labeled “one”. In other embodiments, partial order sets or full order sets of web pages may be developed based on one or more predetermined criterion, so that the web pages are ordered based on such predetermined criterion.

In further embodiments, constraints 126 may be in the form of pair wise preferences for web pages that are labeled by human annotators or mined from implicit user feedback. In the human labeling embodiments, for example, a human annotator may be asked to manually label the relevance of a pair of web pages to a particular query or criteria. Accordingly, the human annotator may label one web page as “relevant”, and a second page as “irrelevant.” In another example of human labeling of pair wise preferences, the human annotator may label one of a pair of web pages as being “preferred” over another web page of the pair based on some criteria.

In other embodiments, the pair wise preferences for web pages may also be mined from click-through logs of a dataset of queries. In such embodiments, the implicit judgment on the relevance of each web page to its corresponding query may be extrapolated from a click-through count (e.g., the larger the click-through count a web page has, the more relevant the web page is to the query). In the pair wise context, if a web page is clicked more than another web page for a given query, a pair wise constraint may be formed to capture such a preference. In scenarios where there may be contradictory pair wise constraints from different queries, a major vote may be used to determine a final pair wise preference. In some embodiments, the SSPR engine 102 may convert the binary labels, partially ordered sets, and/or fully ordered sets into pair wise preferences.

The SSPR engine 102 may optimize the global objective function 124 to acquire parameters for the document features 114 and the edge features 116. The optimization of the global objective function 124 may enable the SSPR engine 102 to compute the static rank scores 128 for the web pages 110.

Thus, the semi-supervised framework used by the SSPR engine 102 to obtain importance rankings of the web pages 110 that are consistent with human intuition may be expressed as follows:

min_{ω≧0,φ≧0,π≧0}R(ω,φ,π;X,Y,G)

s.t. S(π;B,μ)≧0. (1)

As further described below, such a semi-supervised framework has the following properties: (1) it uses a graph structure; (2) it uses the rich information contained in edge features (extracted from inter-relationships between the web pages) and node features (extracted from the web pages themselves); (3) it is a learning framework that may take into account human feedback data as constraints; and (4) it employs a semi-supervised learning scheme in which both labeled and unlabeled data are considered in order to avoid over fitting on a small training set.

### Example Components

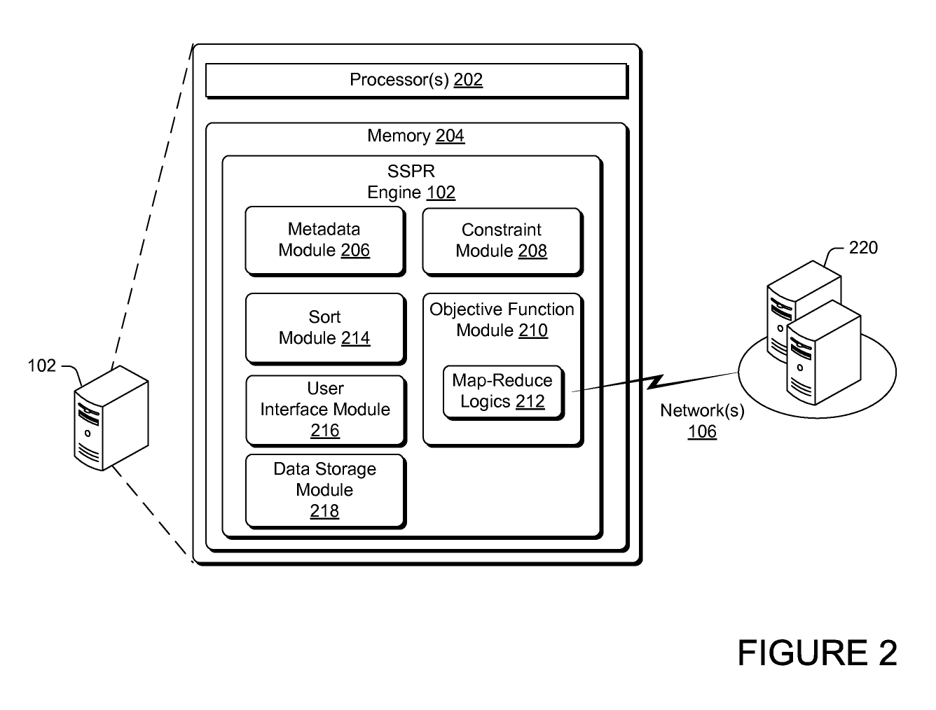

FIG. 2 is a block diagram of selected components of an illustrative SSPR engine that uses human feedback data to produce importance rankings of web pages that are consistent with human intuition, in accordance with various embodiments.

The selected components may be implemented on the computing device 104 (FIG. 1) that may include one or more processors 202 and memory 204. The memory 204 may include volatile and/or nonvolatile memory, removable and/or non-removable media implemented in any method or technology for storage of information, such as computer-readable instructions, data structures, program modules or other data. Such memory may include, but is not limited to, random access memory (RAM), read-only memory (ROM), electrically erasable programmable read-only memory (EEPROM), flash memory or other memory technology; CD-ROM, digital versatile disks (DVD) or other optical storage; magnetic cassettes, magnetic tape, magnetic disk storage or other magnetic storage devices; and RAID storage systems, or any other medium which can be used to store the desired information and is accessible by a computer system. Further, the components may be in the form of routines, programs, objects, and data structures that cause the performance of particular tasks or implement particular abstract data types.

The memory 204 may store components of the SSPR engine 102. The components, or modules, may include routines, programs instructions, objects, and/or data structures that perform particular tasks or implement particular abstract data types. As described above with respect to FIG. 1, the components may include a metadata module 206, a constraint module 208, an objective function module 210 that includes Map-Reduce logics 212, a sort module 214, a user interface module 216, and a data storage module 218.

The metadata module 206 may provide the representative metadata 112 that includes the document features 114, the edge features 116, and the web graph 116 of the web pages 110 to the objective function module 210. In some embodiments, the metadata module 206 may use a search engine to extract the metadata 112 from the World Wide Web 108 via the one or more networks 106. In other embodiments, the metadata module 206 may access the representative metadata 112 that is previously stored in the data storage module 218. In still other embodiments, the metadata module 206 may have the ability to access metadata 112 that is stored on another computing device via the one or more networks 106.

The constraint module 208 may provide constraints 126, or human feedback data, to the objective function module 210. Referring to the semi-supervised framework expressed above as equation (1), the human feedback data may be encoded in a matrix B. Accordingly, if the different weights μ on different samples of supervision are considered, the constraints 126 may be written as S(π; B, μ)≧0. Accordingly, the constraints 126 may ensure that π is consistent with human intuition as much as possible.

In various embodiments, the matrix B can represent different types of supervision, such as binary labels, pair wise preference, partial order, and even total order. For example, pair wise preference may be labeled by human annotators or mined from implicit user feedback. In such cases, B may be an r-by-n matrix with 1, −1, and 0 as its elements, where r is the number of preference pairs. Each row of B represents a pair wise preference u>v, meaning that page u is preferred over page v. The corresponding row of B may have 1 in u's column, −1 in v's column, and zeros in the other columns. Accordingly, the constraints 126 may be written as below, where e is an r-dimensional vector with all its elements equal to 1.

S(π;B,μ)=μ^{T}(e−Bπ)≧0 (2)

In some embodiments, the constraint module 208 may perform data conversions to convert binary labeled web pages, partially order sets of web pages, or fully ordered web pages, to corresponding pair wise preferences prior to applying the constraints that are similar to the constraints descried in equation (2).

For ease of optimization, the constraint module 208 may convert the constraints 126 to an error function in the global objective function 124, and thus the framework expressed as equation (1) may becomes:

min_{ω≧0,φ≧0,π≧0}αR(ω,φ,π;X,Y,G)−βS(π;B,μ) (3)

where α and β are both non-negative coefficients.

The objective function module 210 may combine the regularization term 120 and the loss term 122 to obtain the global objective function 124. Thus, given a graph G containing n pages, the importance of the web pages 110 may be represented as a n-dimensional vector π. The edge features and node features in the web graph 118 may be denoted by the objective function module 210 as X={xᵢⱼ} and Y={yᵢ} respectively. In other words, for each edge from page i to page j, there may be an l-dimensional feature vector xᵢⱼ=(xᵢⱼ₁, xᵢⱼ₂, . . . , xᵢⱼₗ)^{T}; and for each node i, there may be an h-dimensional feature vector yᵢ=(yᵢ₁, yᵢ₂, . . . , yᵢₕ)^{T}. Usually, l and h are small numbers as compared to the scale of the web graph 118. Further, ω and φ may be the parameter vectors to combine edge features and node features.

Accordingly, the objective function R(ω,φ,π;X,Y,G) may be a graph-based regularization term. The objective function R(ω,φ,π;X,Y,G) may serve to ensure that the page importance scores π are consistent with the information contained in the graph in an unsupervised manner. The information in the web graph 118 may consist of graph structure G, edge features X, and node features Y. As such, graph structure G defines the global relationship among pages, edge features X represent the local relationship between two pages, and node features Y describe the single page properties.

Thus, by using the frameworks expressed as equation (1) or equation (3), the objective function module 210 may obtain the optimal ranking scores π* as well as the optimal parameters ω* and φ*. If all the pages of interest have been observed by the frameworks of equation (1) or equation (3), the objective function module 210 may use π* for page importance ranking directly. Otherwise, the objective function module 210 may use the parameters ω* and φ* to construct a graph-based regularization term (e.g., graph-based regularization term 120) that includes new pages previously unobserved by the framework, and then use π* to optimize the new graph-based regularization term for page importance ranking.

In various embodiments, the graph-based regularization term 120 constructed by the objective function module 210 may be based on a Markov random walk on the web graph 118. A key step of the Markov random walk may be written as:

\tilde{π}=dP^{T}π+(1−d)g (4)

where P is the transition matrix and g is the reset probability.

Accordingly, parameters may be introduced to both P and g, and the regularization term may be defined as the loss in the random walk ∥\tilde{π}−π∥², as shown below:

R(ω,φ,π;X,Y,G)=∥dP^{T}(ω;X)π+(1−d)g(φ;Y)−π∥² (5)

where P(ω;X)=P(ω)={pᵢⱼ(ω)} is a parametric transition matrix, in which the value of transition probability from page i to page j may be determined by the combination of edge features 116 using parameter ω. For example, a linear combination as shown below may be used by the objective function module 210:

$${p}_{ij} ( ω ) = \{ \begin{matrix}\frac{{Σ}_{k} {ω}_{k} {x}_{ijk}}{{Σ}_{j} {Σ}_{k} {ω}_{k} {x}_{ijk}} , & if there is an edge from i to j , \\ 0 , & otherwise .\end{matrix} \qquad ( 6 )$$

In other words, only the transition probability for an existing edge in the web graph 118 may be non-zero, and the value is determined by the edge features 116. In other words, the introduction of the edge features 116 may change the weight of an existing edge or remove an existing edge, but will not add new edges to the web graph 118. This may help to maintain the sparsity of the graph. Furthermore, term g(φ;Y)=g(φ) is the parametric reset probability, which combines document (node) features 114 by parameter φ. For example, the linear combination, i.e., gᵢ(φ)=φ^{T}yᵢ may be used by the objective function module 210.

Thus, in embodiments where the constraints 126 are pair wise preferences, the optimization problem for the framework of equation (1) or equation (3) may be expressed as follows:

$${min}_{ω \geq 0 , φ \geq 0 , π \geq 0} α {‖ {dP}^{T} ( ω ) π + ( 1 - d ) g ( φ ) - π ‖}^{2} + β {μ}^{T} ( e - B π ) . \qquad ( 7 )$$

Accordingly, the objective function module 210 may solve this optimization problem (7). Initially, the objective function module 210 may denote the following:

G(ω,φ,π)=α∥dP^{T}(ω)π+(1−d)g(φ)−π∥²+βμ^{T}(e−Bπ). (8)

Subsequently, the objective function module 210 may use a gradient descent method to minimize G(ω,φ,π). The partial derivatives of G(ω, φ,π) with respect to ω, φ, and π may be calculated as below:

$$\begin{matrix} \frac{\partial G}{\partial ω} = 2 α {d [ {P}^{T} π ⊗ π - π ⊗ π + ( 1 - d ) g ⊗ π ]}^{T} \frac{{\partial }_{vec ( P )}}{\partial {ω}^{T}} & ( 9 ) \\ \frac{\partial G}{\partial φ} = 2 α ( 1 - d ) [ ( 1 - d ) g + {dP}^{T} π - π ] \frac{\partial g}{\partial φ} & ( 10 ) \\ \frac{\partial G}{\partial π} = 2 α [ ( {dPP}^{T} - dP - {dP}^{T} + I ) π - ( 1 - d ) ( I - dP ) g ] - β {B}^{T} μ & ( 11 )\end{matrix}$$

In such a gradient descent method, the operator [symbol] may represent the Kronecker product, and the vec(·) operator may denote the expansion of a matrix to a long vector by its columns. Further, the last fractions in (4) and (5) may include the following:

$$\frac{\partial vec ( P )}{\partial {ω}^{T}} = ( \begin{matrix}\frac{\partial {p}_{11}}{\partial {ω}_{1}} & … & \frac{\partial {p}_{11}}{\partial {ω}_{l}} \\ ⋮ & ⋱ & ⋮ \\ \frac{\partial {p}_{n 1}}{\partial {ω}_{1}} & … & \frac{\partial {p}_{n 1}}{\partial {ω}_{l}} \\ ⋮ & ⋱ & ⋮ \\ \frac{\partial {p}_{1 n}}{\partial {ω}_{1}} & … & \frac{\partial {p}_{1 n}}{\partial {ω}_{l}} \\ ⋮ & ⋱ & ⋮ \\ \frac{\partial {p}_{nn}}{\partial {ω}_{1}} & … & \frac{\partial {p}_{nn}}{\partial {ω}_{l}}\end{matrix} ) and \frac{\partial g}{\partial φ} = ( \begin{matrix}\frac{\partial g}{\partial {φ}_{1}} \\ ⋮ \\ \frac{\partial g}{\partial {φ}_{i}} \\ ⋮ \\ \frac{\partial g}{\partial {φ}_{h}}\end{matrix} ) . \qquad ( 12 )$$

Thus, if pᵢⱼ(ω) is a linear function of the edge features 116, and the partial derivatives of the linear function with respect to ωₖ may be written as:

$$\frac{\partial {p}_{ij}}{\partial {ω}_{k}} = \frac{{x}_{ijk} {Σ}_{j} {Σ}_{k} {ω}_{k} {x}_{ijk} - ( {Σ}_{k} {ω}_{k} {x}_{ijk} ) ( {Σ}_{j} {x}_{ijk} )}{{( {Σ}_{j} {Σ}_{k} {ω}_{k} {x}_{ijk} )}^{2}} . \qquad ( 13 )$$

Accordingly, with the above derivatives, the objective function module 210 may iteratively update ω, φ, and π by means of gradient descent. A corresponding algorithm flow is shown in Table 1, in which ρ is the learning rate and ε controls the stopping condition.

TABLE I
Semi-Supervised Page Rank (SSPR) Algorithm Flow

Input: X, Y, B, μ, l, h, n, ρ, ε, α, β.
Output: Page importance score π*
1. Set s = 0, initialize
πᵢ⁽⁰⁾ (i = 1, . . . , n), ωₖ⁽⁰⁾ (k = 1, . . . , l), and φₜ⁽⁰⁾ (t = 1, . . . , h).
2. Calculate P^{(s)} = P(ω^{(s)}), g^{(s)} = g(φ^{(s)}), and G^{(s)} = G(ω^{(s)}, φ^{(s)}, π^{(s)}).
$3. Update {π}_{i}^{( s + 1 )} = {π}_{i}^{( s )} + ρ \frac{\partial {G}^{( s )}}{\partial {π}_{i}^{( s )}} , {ω}_{k}^{( s + 1 )} = {ω}_{k}^{( s )} + ρ \frac{\partial {G}^{( s )}}{\partial {ω}_{k}^{( s )}} , and$ ${φ}_{t}^{( s + 1 )} = {φ}_{t}^{( s )} + ρ \frac{\partial {G}^{( s )}}{\partial {φ}_{t}^{( s )}} .$
$4. Normalize {π}_{i}^{( s + 1 )} ← \frac{{π}_{i}^{( s + 1 )}}{{\sum }_{j = 1}^{n} {π}_{j}^{( s + 1 )}} , {ω}_{k}^{( s + 1 )} ← \frac{{ω}_{k}^{( s + 1 )}}{{\sum }_{j = 1}^{l} {ω}_{j}^{( s + 1 )}} , and$ ${φ}_{t}^{( s + 1 )} ← \frac{{φ}_{t}^{( s + 1 )}}{{\sum }_{j = 1}^{h} {φ}_{j}^{( s + 1 )}} .$
5. Calculate G^{(s+1)} = G(ω^{(s+1)}, φ^{(s+1)}, π^{(s+1)}), if G^{(s)} − G^{(s+1)} < ε,
stop and output π* = π^{(s+1)}; else s = s + 1, jump to step 2.

In some embodiments, the objective function module 210 may use the Map-Reduce logics 212 to reduce the complexity of the objective function optimization, as well as to implement, in parallel, the optimization on multiple computing devices, such as a plurality of computing devices 220 of a data center or a distributed computing cluster.

In various embodiments, by defining π¹=P^{T}π and π″=π′−π, and conducting simple mathematical transformations, the objective function module 210 may degenerate the partial derivative on π to the following:

$$\frac{\partial G}{\partial π} = 2 α [ d ( P {π}^{″} - {π}^{″} ) + ( 1 - d ) ( π - g + dPg ) ] - β {B}^{T} μ . \qquad ( 14 )$$

Thus, the computation of equation (14) may be accomplished using three steps of matrix-vector multiplication: P^{T}π, Pπ″, and Pg.

Further, the computation in equations (9) and (10) may also be simplified with the help of π′ and π″, i.e.,

$$\begin{matrix}\frac{\partial G}{\partial ω} = 2 α d {\{ [ {π}^{″} + ( 1 - d ) g ] ⊗ π \}}^{T} \frac{\partial vec ( P )}{\partial {ω}^{T}} . & ( 15 ) \\ \frac{\partial G}{\partial φ} = 2 α ( 1 - d ) [ ( 1 - d ) g + d {π}^{′} - π ] \frac{\partial g}{\partial φ} . & ( 16 )\end{matrix}$$

Accordingly, by using equation (9), the objective function module 210 may compute the non-zero blocks in the Kronecker product and the partial derivative matrix (12). Thus, suppose there are m edges in the graph, then the cost is proportional to m. As such, the computational complexity of SSPR may be 0(ml+n).

The objective function module 210 may use Map-Reduce logics 212 to implement in parallel the optimization of the global objective function 124. Map-Reduce is a programming model for parallelizing large-scale computations on a distributed computer cluster. It reformulates the logic of a computation task into a series of map and reduce operations. Map operation may take a <key, value> pair, and emits one or more intermediate <key, value> pairs. Then all values with the same intermediate key may be grouped together into a <key, valuelist> pair, so that a value list may be constructed to contains all values associated with the same key. Reduce operation may then read a <key, valuelist> pair and emits one or more new <key, value> pairs.

As described above, there are mainly two kinds of large-scale computation prototypes in SSPR, i.e., matrix-vector multiplication and Kronecker product of vectors on a sparse graph, i.e., the web graph 118. Accordingly, these prototypes can be written using Map-Reduce logics 212.

With respect to matrix-vector multiplication, for the example π′=P^{T} π, each row equation in π′=P^{T}π is π′ᵢ=Σⱼ pⱼᵢπⱼ, which can be implemented as follows:
Map: map <i,j,pⱼᵢ> on i such that tuples with the same i are shuffled to the same computing device in the form of <i,(j,pⱼᵢ)>.
Reduce: take <i,(j,pⱼᵢ)> and calculate <i,Σⱼ pⱼᵢπⱼ>, and then emit π′ᵢ, π′ᵢ=Σⱼ pⱼᵢπⱼ.

With respect to the Kronecker product, given that x and y are both n-dimensional vectors, the objective function module 210 may compute the Kronecker product z=x [symbol] y (z is an n²-dimensional vector) of them on a sparse graph, i.e., the web graph 118. Thus, the objective function module 210 may cause xᵢyⱼ to be computed if there is an edge from page i to page j in the web graph 118. The operations may be implemented as below:
Map: map <i,xᵢ> on i such that tuples with the same i are shuffled to the same computing device.
Reduce: take <i,xᵢ> and calculate <i,xᵢyⱼ> only if there is an edge from page i to page j, and then emit z₍ᵢ₋₁₎ₙ₊ⱼ=xᵢyⱼ; otherwise, z₍ᵢ₋₁₎ₙ₊ⱼ=0.
   In other embodiments, additional operations performed by the SSPR engine 102 may also be implemented using Map-Reduce logics 212, including vector normalization, vector addition (and subtraction), and the gradient updating rules.

In the embodiments where the objective function module 210 uses the Map-Reduce logics 212, the objective function module 210 may have the ability to transmit data to the plurality of computing devices 220, as well as to receive optimization results, or static rank scores 128 from the plurality of computing devices 220, via the one or more networks 106. The objective function module 210 may store the static rank scores 128 in the data storage module 216.

The sort module 214 may order the plurality of web pages 110 according to the static rank scores 128 generated by the objective function module 210. In various embodiments, the sort module 214 may obtain the static rank scores 128 from the data storage module 216 to order the plurality of web pages 110. In other embodiments, the sort module 214 may further transmit the static rank scores 128 to another computing device.

The user interface module 216 may interact with a user via a user interface (not shown). The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods. The user interface module 216 may enable a user to select the web pages to rank, import metadata 114 and/or constraints 126 from other computing devices, control the various modules of the SSPR engine 102, select the computing devices for the implementation of parallelized optimization, as well as direct the transmission of the obtained static rank scores 128 to other computing devices.

The data storage module 218 may store the metadata 122, which may include the document features 114, the edge features 116, the web graph 118, as well as the constraints 126. The data storage module may also store the obtained static rank scores 128. The data storage module 218 may also store any additional data used by the SSPR engine 102, such as various additional intermediate data produced during the production of the static rank scores 128, such as the results of the matrix vector multiplication and the Kronecker product produced by the various modules.

### Example Process

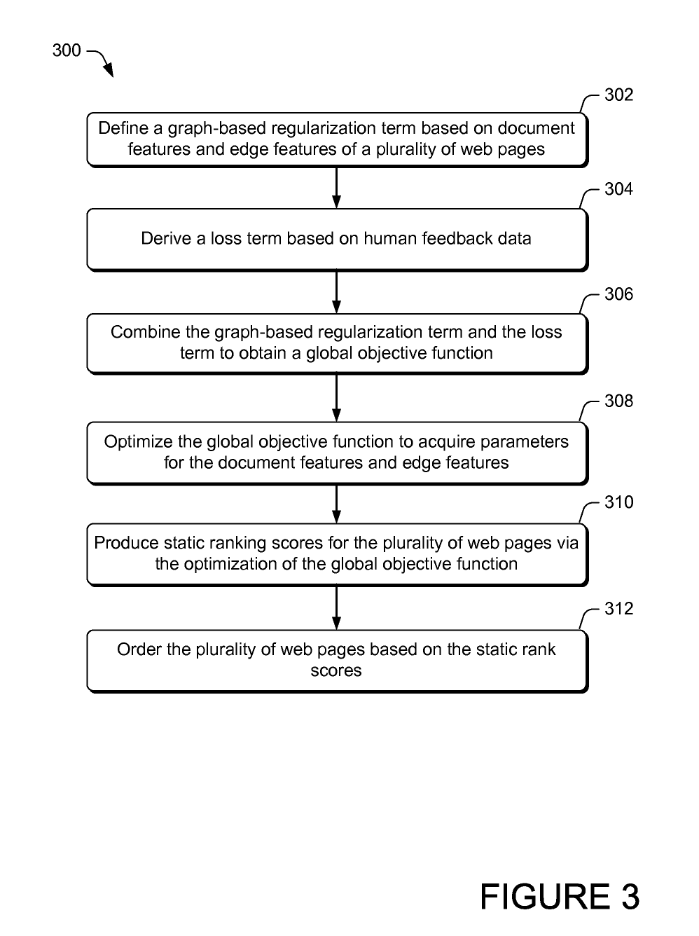

FIG. 3 is a flow diagram of an illustrative process 300 to generate importance rankings of web pages that are consistent with human intuition, in accordance with various embodiments. The order in which the operations are described in the example process 300 is not intended to be construed as a limitation, and any number of the described blocks may be combined in any order and/or in parallel to implement each process. Moreover, the blocks in the example process 300 may be operations that can be implemented in hardware, software, and a combination thereof. In the context of software, the blocks represent computer-executable instructions that, when executed by one or more processors, cause one or more processors to perform the recited operations. Generally, computer-executable instructions may include routines, programs, objects, components, data structures, and the like that cause the particular functions to be performed or particular abstract data types to be implemented.

At block 302, the objective function module 210 of the SSPR engine 102 may define a regularization term based on the document features 114, the edge features 116, and the web graph 118 of a plurality of web pages, such as the web pages 110. In various embodiments, the document features 114 for each web page, also known as node features, may include one or more of (1) the number of inbound to the web page; (2) the number of outbound links from the web page (node); (3) the number of neighboring web pages that are at distance 2, that is, at one or more nodes that are twice removed the web page (node); (4) the universal resource locator (URL) depth of the web page (node); or (5) the URL length of the web page (node).

The edge features 116 may be derived from the relationships between multiple web pages, these features may include one or more of (1) whether the two web pages are intra-website web pages or inter-website web pages; (2) the number of inbound links of the source and destination web pages (nodes) at each edge; (3) the number of outbound links of the source and destination web pages (nodes) at each edge; (4) the URL depths of the source and destination web pages (nodes) at each edge; or (5) the URL lengths of the source and destination web pages (nodes) at each edge.

At block 304, the SSPR engine 102 may use the constraint module 208 to derive a loss term based on human feedback data. In various embodiments, the human feedback data may be manual annotation of web pages or mined from implicit user feedback. The human feedback data may be in the form of binary labels, pair wise preferences, partially ordered sets, or fully ordered sets. In various embodiments, the constraint module 208 may convert the constraints from the human feedback data to the loss term using the L₂ distance, that is, the Euclidean distance, between the ranking results given by the parametric model and the human feedback data.

At block 306, the objective function module 210 may combine the regularization term 120 and the loss term 122 to obtain a global objective function 124. In this way, the human feedback data may serve to correct the ranking results.

At block 308, the objective function module 210 may optimize the global objective function 124 to acquire parameters for the document features 114 and the edge features 116. In some embodiments, the objective function module 210 may use Map-Reduce logics 212 to complete at least a part of the optimization on a distributed computing cluster, such as a plurality of computing devices 220 of a data center.

At block 310, the optimization of the global objective function 124 may produce the static rank scores 128 for the plurality of web pages 110. The static rank scores 128 for the plurality of web pages 110 may be stored in the data storage module 218.

At block 312, the sort module 214 may order the plurality of web pages 110 based on the static rank scores 128. Thus, when a search engine receives a query, the search engine may retrieve at least some of the plurality of web pages 110 and present them according to the corresponding static rank scores 128.

### Example Electronic Device

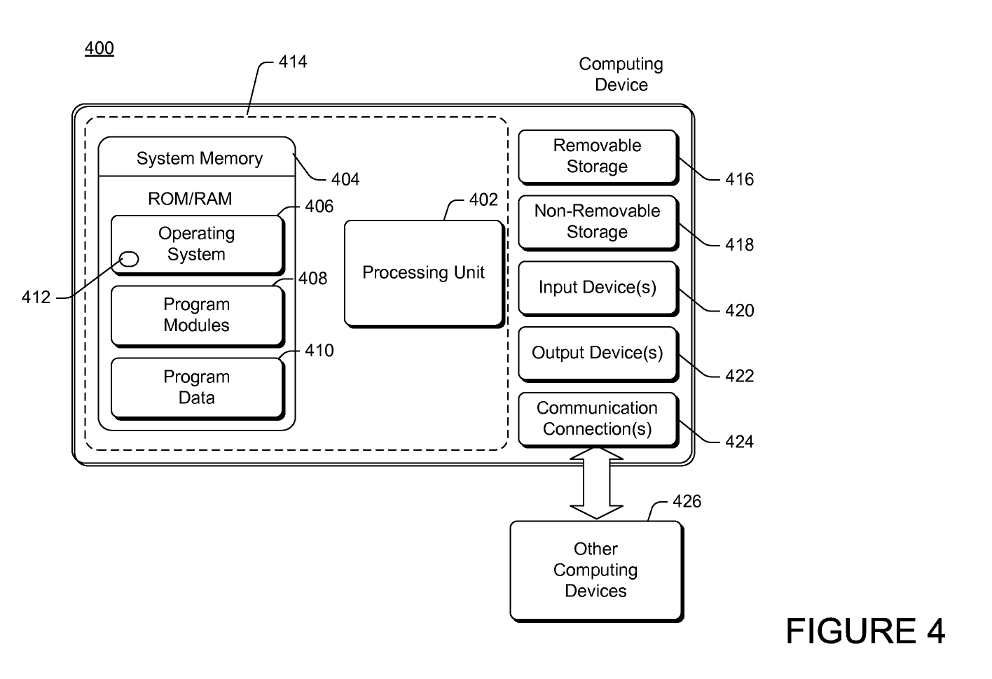

FIG. 4 illustrates a representative electronic device 400 that may be used to implement a SSPR engine 102 that generates importance rank scores for web pages that are consistent with human intuition. However, it is understood that the techniques and mechanisms described herein may be implemented in other electronic devices, systems, and environments. The electronic device 400 shown in FIG. 4 is only one example of an electronic device and is not intended to suggest any limitation as to the scope of use or functionality of the computer and network architectures. Neither should the electronic device 400 be interpreted as having any dependency or requirement relating to any one or combination of components illustrated in the example electronic device.

In at least one configuration, electronic device 400 typically includes at least one processing unit 402 and system memory 404. Depending on the exact configuration and type of electronic device, system memory 404 may be volatile (such as RAM), non-volatile (such as ROM, flash memory, etc.) or some combination thereof. System memory 404 may include an operating system 406, one or more program modules 408, and may include program data 410. The operating system 406 includes a component-based framework 412 that supports components (including properties and events), objects, inheritance, polymorphism, reflection, and provides an object-oriented component-based application programming interface (API), such as, but by no means limited to, that of the .NET™ Framework manufactured by the Microsoft® Corporation, Redmond, Wash. The electronic device 400 is of a very basic configuration demarcated by a dashed line 414. Again, a terminal may have fewer components but may interact with an electronic device that may have such a basic configuration.

Electronic device 400 may have additional features or functionality. For example, electronic device 400 may also include additional data storage devices (removable and/or non-removable) such as, for example, magnetic disks, optical disks, or tape. Such additional storage is illustrated in FIG. 4 by removable storage 416 and non-removable storage 418. Computer storage media may include volatile and nonvolatile, removable and non-removable media implemented in any method or technology for storage of information, such as computer readable instructions, data structures, program modules, or other data. System memory 404, removable storage 416 and non-removable storage 418 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Electronic device 400. Any such computer storage media may be part of device 400. Electronic device 400 may also have input device(s) 420 such as keyboard, mouse, pen, voice input device, touch input device, etc. Output device(s) 422 such as a display, speakers, printer, etc. may also be included.

Electronic device 400 may also contain communication connections 424 that allow the device to communicate with other electronic devices 426, such as over a network. These networks may include wired networks as well as wireless networks. Communication connections 424 are some examples of communication media. Communication media may typically be embodied by computer readable instructions, data structures, program modules, etc.

It is appreciated that the illustrated electronic device 400 is only one example of a suitable device and is not intended to suggest any limitation as to the scope of use or functionality of the various embodiments described. Other well-known electronic devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The use of a graph-based regularization term and/or the Map-Reduce logics by the SSPR engine may reduce the amount of computation for the purpose of page important ranking while improving the human perceived reasonableness of the output web page rankings. Accordingly, user satisfaction with web search results of search engines that implement the SSPR engine may be increased.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer readable medium storing computer-executable instructions that, when executed, cause one or more processors to perform operations comprising:
defining a graph-based regularization term based on document features, edge features, and a web graph of a plurality of web pages;
deriving a loss term based on human feedback data;
combining the graph-based regularization term and the loss term to obtain a global objective function;
optimizing the global objective function to obtain parameters for the document features and edge features and produce static rank scores for the plurality of web pages; and
ordering the plurality of web pages based on the static rank scores.

2. The computer readable medium of claim 1, wherein the document features include one or more of number of inbound links to a web page, number of outbound links from the web page, number of neighboring web pages that are twice removed from the web page, a universal resource locator (URL) depth of the web page, or a URL length of the web page.

3. The computer readable medium of claim 1, wherein the edge features includes one or more of whether two web pages are intra-website web pages or inter-website web pages, number of inbound links of a source web page and a destination web page at each edge, number of outbound links of a source web page and a destination web page at each edge, URL depths of the source web page and destination web page at each edge, or URL lengths of the source web page and destination web page at each edge.

4. The computer readable medium of claim 1, wherein the defining includes defining the graph-based regularization term using a parametric model, and the deriving includes converting constraints from the human feedback data to the loss term using a Euclidean distance between ranking results given by the parametric model and the human feedback data.

5. The computer readable medium of claim 1, wherein the human feedback data is based on manually annotated web pages or mined from implicit user feedback.

6. The computer readable medium of claim 1, wherein the human feedback data includes at least one of binary labels, pair wise preferences, partially ordered sets, or fully ordered sets.

7. The computer readable medium of claim 1, wherein the deriving includes deriving the loss term based on human feedback data in form of pair wise preferences.

8. The computer readable medium of claim 1, wherein the deriving further includes converting human feedback data in form of binary labels, partially ordered sets, or fully ordered sets to the pair wise preferences.

9. The computer readable medium of claim 1, wherein the optimizing includes applying Map-Reduce logic to implement the optimizing as parallel computations on a plurality of computing devices.

10. The computer readable medium of claim 1, wherein the optimizing includes applying a matrix-vector multiplication and Kronecker product of vectors to the web graph.

11. A computer implemented method, comprising:
defining a graph-based regularization term based on document features, edge features, and a web graph of a plurality of web pages;
deriving a loss term based on human feedback data in form of pair wise preferences;
combining the graph-based regularization term and the loss term to obtain a global objective function;
applying Map-Reduce logic to implement parallel computations on a plurality of computing devices to optimize the global objective function to obtain parameters for the document features and edge features and produce static rank scores for the plurality of web pages; and
ordering the plurality of web pages based on the static rank scores.

12. The computer implemented method of claim 11, wherein the document features include one or more of number of inbound links to a web page, number of outbound links from the web page, number of neighboring web pages that are twice removed from the web page, a universal resource locator (URL) depth of the web page, or a URL length of the web page.

13. The computer implemented method of claim 11, wherein the edge features include one or more of whether two web pages are intra-website web pages or inter-website web pages, number of inbound links of a source web page and a destination web page at each edge, number of outbound links of a source web page and a destination web page at each edge, URL depths of the source web page and destination web page at each edge, or URL lengths of the source web page and destination web page at each edge.

14. The computer implemented method of claim 11, wherein the defining includes defining the graph-based regularization term using a parametric model, and the deriving includes converting constraints from the human feedback data to the loss term using a Euclidean distance between the ranking results given by the parametric model and the human feedback data.

15. The computer implemented method of claim 11, wherein the human feedback data is based on manually annotated web pages or mined from implicit user feedback.

16. The computer implemented method of claim 11, wherein the deriving includes converting feedback data in form of binary labels, partially ordered sets, or fully ordered sets to the pair wise preferences.

17. The computer implemented method of claim 11, wherein the optimizing includes applying matrix-vector multiplication and Kronecker product of vectors to the web graph.

18. A system, comprising:
one or more processors;
a memory that includes components that are executable by the one or more processors, the components comprising:
a metadata component to define a graph-based regularization term based on document features, edge features, and a web graph of a plurality of web pages using a parametric model;
a constraint component to derive a loss term based on human feedback data by converting constraints from the human feedback data to a loss term using a Euclidean distance between ranking results given by the parametric model and the human feedback data;
an objective function component to combine the graph-based regularization term and the loss term to obtain a global objective function, and to optimize the global objective function to obtain parameters for the document features and edge features and produce static rank scores for the plurality of web pages; and
a sort component to order the plurality of web pages based on the static rank scores.

19. The system of claim 18, wherein the document features include one or more of number of inbound links to a web page, number of outbound links from the web page, number of neighboring web pages that are twice removed from the web page, a universal resource locator (URL) depth of the web page, or a URL length of the web page, and wherein the edge features includes one or more of whether two web pages are intra-website web pages or inter-website pages, number of inbound links of a source web page and a destination web page at each edge, number of outbound links of a source web page and a destination web page at each edge, URL depths of the source web page and destination web page at each edge, or URL lengths of the source web page and destination web page at each edge.

20. The system of claim 18, wherein the objective function component is to optimize the global objective function by applying a matrix-vector multiplication and Kronecker product of vectors to the web graph.
